(19) United States
(12) Patent Application Publication
(10) Pub. No.: US 2020/0332928 A1
(43) Pub. Date: Oct. 22, 2020

(54) LONG FLEXIBLE TUBING ELEMENT (VARIANTS)

(71) Applicant: UCT TECHNOLOGIES LIMITED LIABILITY COMPANY [RU/RU], Moscow (RU)

(72) Inventor: Rivener Musavirovich GABDULLIN, Moscow (RU)

(73) Assignee: UCT TECHNOLOGIES LIMITED LIABILITY COMPANY [RU/RU], Moscow (RU)

(21) Appl. No.: 16/956,177

(22) PCT Filed: Jan. 11, 2019
(86) PCT No.: PCT/RU2019/000007

§ 371 Date: Jun. 19, 2020

(30) Foreign Application Priority Data
Jan. 22, 2018 (RU) 2018102371

(51) Int. Cl. F16L 11/22; F16L 11/14; E21B 17/20; E21B 19/22

(52) U.S. Cl. CPC F16L 11/22; F16L 11/14; E21B 17/01; E21B 19/22; E21B 17/203

(57) ABSTRACT

The invention relates to lengthy umbilical flexible tubing that can be wound on a reel, and more particularly to coiled tubing or flexible production tubing. The technical effect is to increase the potential of well process operations. A lengthy umbilical flexible tubing element comprises at least two isolated channels combined to form a single structure. The isolated channels are joined to one another by an interfacing partition formed by welding the points of connection between the walls of the isolated channels to one another. The at least two isolated channels and the interfacing partition are formed from two separate metal strips by shaping said metal strips from the middle by longitudinal bending, and subsequently welding the opposing longitudinal edges of the two metal strips to one another. Jointing or dividing partition is provided with holes and is double the thickness of a metal strip. One of the metal strips is made of steel that exhibits high strength under tension, and the other metal strip is made of steel that exhibits high ductility under compression.

### FIELD OF THE INVENTION

The invention relates to boreholes, namely, long-dimensional flexible tubes (coiled tubing, or lengthy flexible tubing), more specifically, coiled tubing winding onto a reel.

### BACKGROUND

As practice of coiled tubing application in boreholes shows, it is reasonable to have multi-channel umbilical coiled tubing with various diameters, designs, and auxiliary service channels for implementation of many technological operations inside boreholes as well as reservoir fluid lifting using different artificial lift methods. Multi-channel umbilical coiled tubing is needed also in geotechnical engineering, in particular, in production processes based on conversion of solid minerals into a mobile state (for example, liquid or friable) in order for delivering to surface by tubular strings inside boreholes.

A multi-channel coiled tubing is known comprising several hydraulic and electrical channels, which are enclosed together in a single fused shell extruded from a polymer material with two flat surfaces for easy spooling. The extruded enclosure from polymeric material around the hydraulic and electrical channels forms a single multi-channel string in the shape of a long-dimensional flexible tape, which provides good protection for the hydraulic and electrical channels. Specific quantities and diameters of electric and hydraulic channels depend on whether electrical centrifugal submersible pump or hydraulic downhole pump is used. The hydraulic channels may comprise standard coiled tubing, standard plastic long-dimensional flexible pipes, or capillary tubes while electrical and information channels may comprise electrical wires or cables and fiber-optic lines (U.S. Pat. No. 8,459,965 issued Jun. 11, 2013).

One disadvantage of above-mentioned multi-channel umbilical coil tubing consists in increased weight of the multi-channel string due to deposited plastic. Another disadvantage is necessity to cut through the solid plastic enclosure in order to repair or replace a damaged electric line section (breakdown, earth fault, etc.) or fiber-optic or capillary line section (disrupted channel) followed by re-welding of plastic. In addition, deep and long scratches or abrasions on outer surface of plastic adversely affect the tightness of stripper (annular seal) and blowout preventer equipment.

A multi-channel umbilical ArmorPak long flexible tubing and method of its assembly by installing permanent weld clamps on joints of standard flexible tubes (coil tubing) are known (www.cjstech.com). The multi-channel umbilical ArmorPak long coil tubing string is coiled off from the reel of coil tubing rig into a borehole to perform downhole operations or lifting of well fluid using, for example, submersible electric centrifugal pumps or hydraulic downhole pumps. If needed, additional standard flexible tubes (coil tubing) can be installed in the multi-channel umbilical long-dimensional ArmorPak flexible piping system either separately or inside desired channels.

Principal disadvantage of above mentioned configurable multi-channel umbilical flexible tubing is stepwise change in cross-section geometry of the string in the place of permanent weld clamps installation, which impairs integrity of the multi-channel umbilical coiled tubing system and its ability to pass through the stripper and blowout preventer. As a result, sealing ability of well equipment degrades and its service life decreases. There are also technical difficulties in assembling a multi-channel umbilical flexible tubing with three or more service channels.

A multi-channel umbilical flexible tubing and method of its producing that includes placing one or few long-dimensional service channels, designed to deliver electrical energy, hydraulic energy, or fluids to a well and receiving borehole information on the surface, into a larger main coiled tubing, which is formed by wrapping a metal strip around the insulated service channel(s) and thereafter welding longitudinal edges of the metal strip (U.S. Pat. No. 8,925,627 issued Jan. 6, 2015) is also known and may be considered as the closest prior art.

The disadvantage of aforementioned multi-channel umbilical flexible tubing is related with increased weight, rigidity and cost of the string due to rigid in-factory bundling of all channels into a single long-dimensional unit assembled from standard circular coiled tubing, all channels being placed inside the main outer large-diameter coil tubing, which has to bear entire weight of multi-channel string when being suspended on injector head, thereby causing the necessity to increase wall thickness of the coil tubing and use steels of higher grades. In addition, a complex and expensive termination and sealing at both ends of a multi-channel umbilical flexible tubing with different internal channels is required, and there are difficulties with suspension of the internal channels in the wellhead.

### SUMMARY OF THE INVENTION

Therefore, it is the object of the present invention to provide a reliable element of an umbilical flexible tubing produced from two metal strips and comprising two or more isolated hydraulic channels with various diameters and cross-sections.

The aim of this invention is to produce a multi-channel (umbilical) flexible tubing using a multi-stage shaping and welding of metal strips into a suitable geometry that matches to a desired well technology or artificial lifting method and enables to arrange weld seams, connecting, jointing and dividing partitions, thick parts of the string on the string midline as well as additional detachable service (process) channels inside or outside the multi-channel umbilical flexible tubing.

According to present invention, the stated problem is solved, and the stated aim is achieved, by an element of a lengthy umbilical flexible tubing, comprising at least two isolated channels, integrated into a single structure, wherein the isolated channels are joined together by a connecting partition formed by welding overlapping parts of walls of the isolated channels to each other; the isolated channels and the connecting partition are formed from two separate metal strips by shaping from a center of each metal strip by bending the metal strips longitudinally followed by welding opposite longitudinal edges of the two metal strips to each other; and the connecting partition is made with holes (perforated) and has a thickness that is about twice of a thickness of the metal strips.

In some embodiments, welding seams, the perforated connecting partition and centers of isolated channels are located on the middle line of umbilical flexible tubing's cross-section.

In some embodiments, the flexible service belt with connecting locking cams is mounted on the connecting partition, wherein locking cams coincide with the holes on the connecting partition, and the cams and holes form a locking element, and wherein the service belt is configured in such a way that electrical cables, wires, capillary tubes, fiber optic lines are placed therein.

In some embodiments, a distance (spacing) between two neighboring locking cams is at least two times longer than a distance between two neighboring holes in the perforated connecting partition.

Also, according to present invention, the stated problem is solved, and the stated aim is achieved, by an element of a lengthy umbilical flexible tubing, comprising two isolated channels integrated into a single structure, wherein the isolated channels are joined together by a jointing partition, formed by welding overlapping parts of walls of the isolated channels to each other; the two isolated channels and the jointing partition are formed from two separate metal strips by shaping from a center of each metal strip by bending longitudinally both edges of the metal strips to form an inner isolated channel followed by subsequent welding of contacting longitudinal edges of the metal strips to each other, and then shaping remaining two edges of the metal strips to form an outer isolated channel with subsequent welding of contacting longitudinal edges of the metal strips to each other.

Also, according to present invention, the stated problem is solved, and the stated aim is achieved, by forming isolated channels, in an element of a lengthy umbilical flexible tubing, comprising two isolated channels integrated into a single structure, wherein the isolated channels are formed from two metal strips by separately shaping each metal strip with subsequent welding longitudinal edges of each strip to each other, whereby forming said two separate isolated channels; wherein each of said isolated channels has a crescent-shaped cross-section consisting of two circular arcs, interconnected by ends and forming a convex in the same direction, or a half-ring shape consisting of two circular arcs of different radii having ends connected by diametrical straight lines, and wherein the two isolated channels are welded to each other in places of their longitudinal mirror alignment to form an additional (third) isolated channel between them.

Also, according to present invention, the stated problem is solved, and the stated aim is achieved, by forming isolated channels, in an element of umbilical flexible tubing, comprising at least two combined in a single structure isolated channels, from two metal strips by separate shaping each metal strip with subsequent welding of longitudinal edges of both metal strips to bodies of the shaped metal strips to form two separate isolated channels and lateral longitudinal shaped lamellae, followed by welding longitudinal edges of these lamellae to bodies of opposite shaped metal strips to form an additional (third) isolated channel between them.

Also, according to present invention, the stated problem is solved, and the stated aim is achieved, by forming isolated channels, in an element of umbilical flexible tubing, comprising at least two combined in a single structure isolated channels, from two metal strips by separate shaping each strip with subsequent welding of longitudinal edges of both metal strips with each other to form two separate isolated channels, each of isolated channels having a semicircle shape in cross-section; these two isolated channels are connected to each other along diametrical planes by longitudinal welding to form a common dividing partition, so that an outside line of cross-section of the tubing has a circle shape in cross-section.

Also, according to present invention, the stated problem is solved, and the stated aim is achieved, by forming isolated channels, in an element of umbilical flexible tubing, comprising at least two combined in a single structure isolated channels, from two metal strips by separate shaping each metal strip with subsequent welding of longitudinal edges of both metal strips to bodies of the shaped metal strips to form two separate inner isolated channels and two jointing partitions, followed by further shaping each metal strip body and welding longitudinal edges of each metal strip to the jointing partition of opposite inner isolated channel to form two additional outer isolated channels.

In some embodiments, one metal strip is made of steel with high tensile strength properties, whereas the second metal strip is made of steel with high compressive strength properties; and winding onto a reel is performed with the shaped metal strip having high compressive strength properties faced to the reel.

### BRIEF DESCRIPTION OF THE DRAWINGS

The present summary is illustrated by the cross-sectional drawings of elements of umbilical flexible tubing. Welding operations are conducted along longitudinal lines of the metal strip, welding locations are indicated by arrows, the order of welding sequence is shown by Roman numerals, the welding seam on the cross section is shown by a bold line.

FIGS. 1 and 2 illustrate manufacturing of element of an umbilical flexible tubing of the type “pipes abreast with partition” (two isolated channels) from two metal strips.

FIG. 3 shows element of an umbilical flexible tubing of the type “pipes abreast with partition” (two isolated channels) (two isolated channels) with attached service tape.

FIGS. 4 to 6 illustrate manufacturing of element of an umbilical flexible tubing of the type “pipe in pipe” (two isolated channels) from two metal strips.

FIGS. 7 and 8 illustrate manufacturing of element of an umbilical flexible tubing with three isolated channels formed from two separate isolated channels with crescent-shaped cross-section (FIG. 7) or half-ring cross-section (FIG. 8).

FIG. 9 shows element of an umbilical flexible tubing with two isolated channels formed from two separate isolated channels with half-ring cross-section.

FIGS. 10 and 11 illustrate manufacturing of element of an umbilical flexible tubing with circular cross-section enclosing three isolated channels of the type “identical pipes in pipe” formed from two separate isolated channels with lateral lamellae.

FIG. 12 shows element of an umbilical flexible tubing with elliptical cross-section enclosing isolated channels of the type “different pipes in pipe” formed from two separate isolated channels with lateral lamellae.

FIG. 13 shows element of an umbilical flexible tubing of the type “pipes abreast with partition” with separate standard coiled tubing and a standard armored electrical cable fastened with clamps.

FIG. 14 illustrates manufacturing of another embodiment of element of an umbilical flexible tubing with three isolated channels of the type “three parallel pipes with partitions” from two metal strips.

FIG. 15 illustrates manufacturing of still another embodiment of element of an umbilical flexible tubing with circular cross-section enclosing three isolated channels of the type “different pipes in pipe” from two metal strips.

### DESCRIPTION OF THE PREFFERED EMBODIMENT OF THE INVENTION

An element of umbilical flexible tubing consists of two shaped and specially welded together metal strips (A and B), the method of manufacturing the umbilical flexible tubing consisting of one or several stages of profiling (shaping) and welding, embodiments of said element of umbilical flexible tubing and said method of manufacture being presented below.

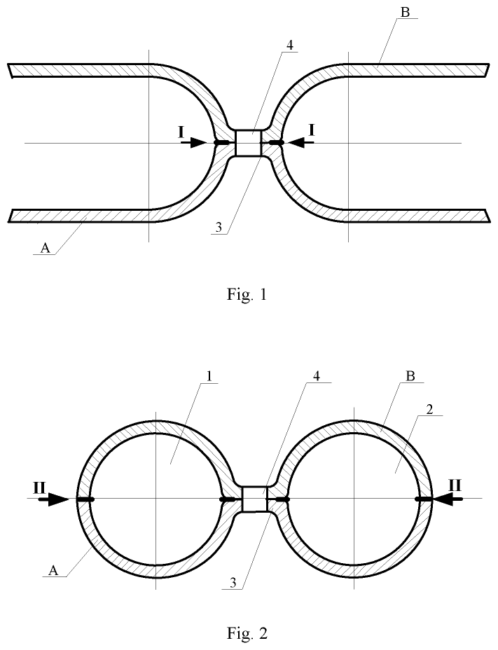

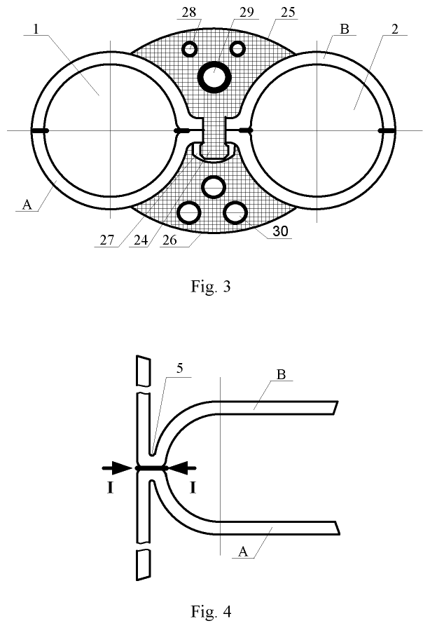

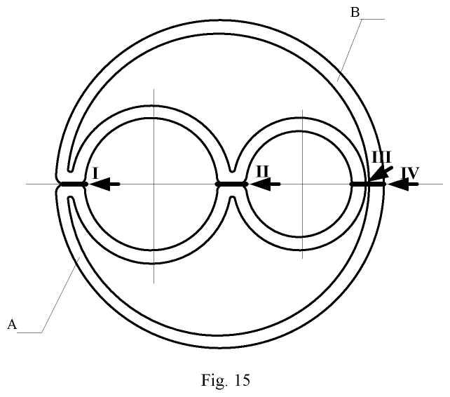

First embodiment of element of umbilical flexible tubing of the type “channels abreast with partition” is presented in FIG. 1, and method of manufacturing thereof from two metal strips A and B (rolls of metal strip) includes separate profiling (shaping) of each metal strip according to pre-specified geometry and subsequent welding of the shaped metal strips to each other in pre-specified places at the first stage. At the second stage, so obtained welded two-metal strip semi-finished product is re-shaped, and its opposite longitudinal edges are welded to each other (FIG. 2) to form an element of umbilical flexible tubing, in which isolated channels 1 and 2 are interconnected by a connecting partition 3 having a double metal strip thickness. The connecting partition 3 has holes 4 and designed for rigid connection of two hydraulic channels 1 and 2, at least partial relief of tubing due to injector tracks pressure and string weight transfer from tubing body to the connecting partition 3 owing to injector gear load-carrying elements entering to holes 4 of the connecting partition 3, optional application of elevators with fingers designed to enter to holes 4 of the connecting partition 3, optional easy and reliable installation of additional service channels into the elastic tape 25 and/or 26 on the connecting partition 3 (FIG. 3) during tripping in hole (TIH) and easy and reliable detachment installed channels during tripping out of hole (TOH), and possible repair of long-dimensional string (by means of cutting off a rejected channel along connecting partition 3 and re-welding operable tubing in its place). Additional load-carrying metal tapes (not shown) can be welded or riveted to the connecting partition 3 from one or both sides if working with deep boreholes or heavy strings to transfer most or all of injector tracks pressure and string weight from the tube body to the connecting partition 3, which will increase service life of isolated channels and the string itself. As a special case of the first embodiment, it is possible to manufacture a three-channel embodiment of the element of long umbilical flexible tubing (FIG. 14) with two connecting partitions and with different diameters of isolated channels.

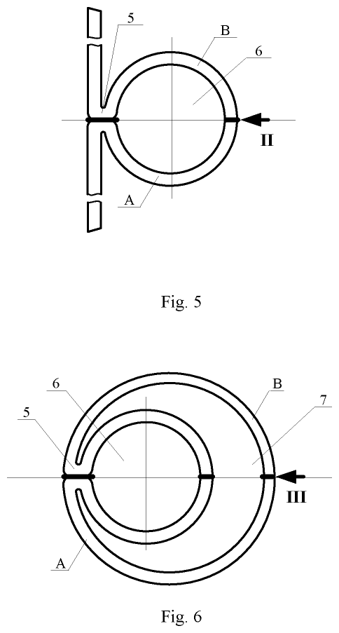

Second embodiment of element of umbilical flexible tubing of the type “channel in channel” is presented in FIG. 4, and method of manufacturing thereof from two metal strips A and B (rolls of metal strip) includes separate profiling of each metal strip according to pre-specified geometry and subsequent welding of the shaped metal strips to each other in pre-specified places to form a jointing partition 5 at the first stage. At the second stage, thus obtained two-metal strip semi-finished product is re-shaped, and its short opposite longitudinal edges are welded to each other (FIG. 5) to form a smaller isolated channel 6. At the third stage, above obtained two-metal strip semi-finished product with the small isolated channel 6 is re-shaped again and the long opposite longitudinal edges are welded to each other (FIG. 6) to form a larger isolated channel 7 in such way that said smaller isolated channel 6 was enclosed inside it and fixed to it by the jointing partition 5, while weld seams, centers of the channels 6 and 7, and the jointing partition 5 were located on the midline of the two-channel string cross-section. As a special case of the second embodiment, it is possible to manufacture a three-channel embodiment of the element of long umbilical flexible tubing with two jointing partitions (FIG. 15). The larger channel may also have an elliptical cross-section.

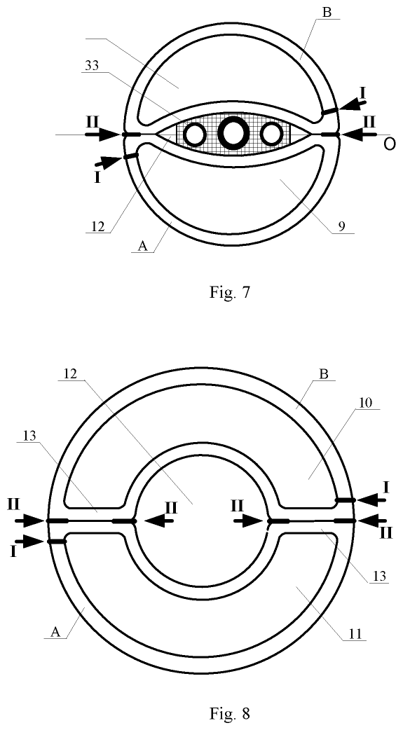

Third embodiment of element of umbilical flexible tubing of the type “two channels plus” is presented in FIGS. 7 and 8, and method of manufacturing thereof from two metal strips A and B includes separate shaping of each metal strip according to pre-specified geometry using different profiling techniques and subsequent welding of longitudinal edges of each metal strip with each other to form either two separate isolated channels 8 and 9, each of isolated channels having the crescent-shaped cross-section (FIG. 7) consisting of two circular arcs interconnected at ends and turned in the same direction by convexities, or two separate isolated channels 10 and 11, each of isolated channels having a half-ring cross-section (FIG. 8) consisting of two circular arcs of different radii interconnected by radial planes 13 at ends and turned by convexities in one direction, so formed two isolated separate channels 10 and 11 being welded to each other in places of their longitudinal mirror alignment to form an additional (third) isolated channel 12 between them.

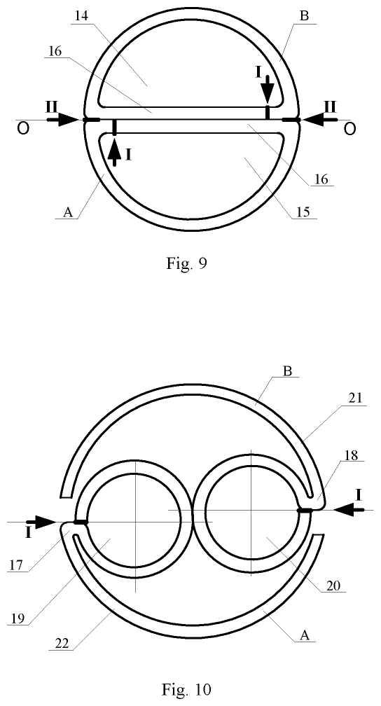

Fourth embodiment of element of umbilical flexible tubing of the type “two aligned channels” is presented in FIG. 9, and method of manufacturing thereof from two metal strips A and B includes separate shaping of each metal strip according to pre-specified geometry and subsequent welding of longitudinal edges of each metal strip with each other to form two separate single-metal strip isolated tubing channels 14 and 15 having half-ring cross-section (FIG. 9), so formed two isolated separate channels are welded to each other in places of their longitudinal mirror alignment to form a partition 16 with thickness equal to double metal strip thickness and to provide the element of umbilical flexible tubing with circular cross-section.

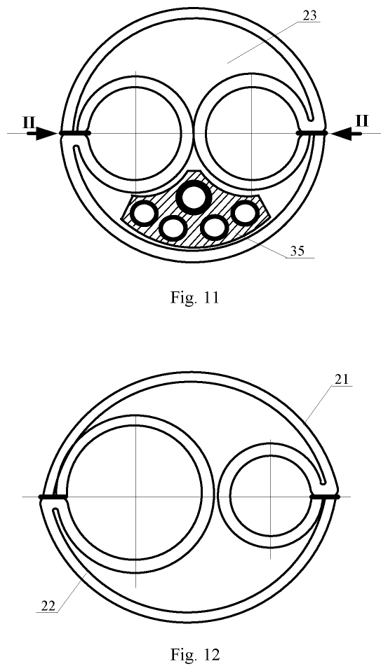

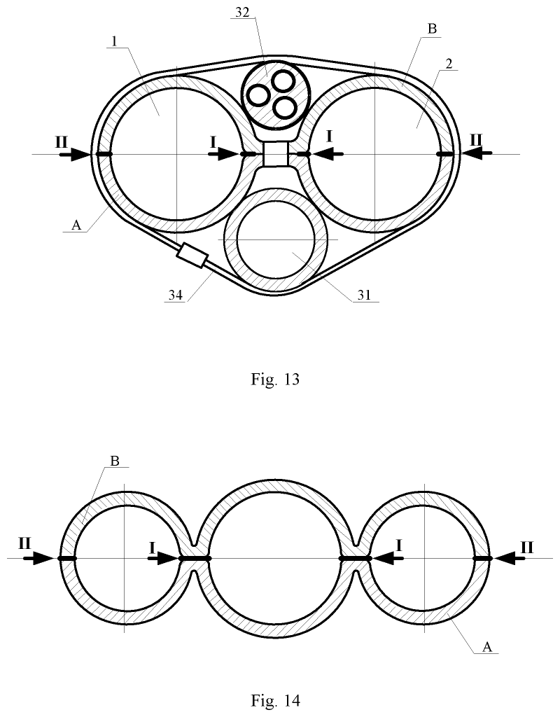

Fifth embodiment of element of umbilical flexible tubing of the type “channel in channel” is presented in FIG. 10, and the method of manufacturing thereof from two metal strips A and B includes separate shaping of each metal strip according to pre-specified geometry and subsequent welding of longitudinal edges to body of each shaped metal strip in pre-specified places (FIG. 10) to form two identical welded semi-finished products with jointing partitions 17 and 18, isolated channels 19 and 20, and lateral longitudinal lamellae 21 and 22. At the second stage, the lateral longitudinal lamellae 21 and 22 of both welded semi-finished products are re-shaped again, and the longitudinal edges of lateral longitudinal lamellae are welded to opposite jointing partitions 17 and 18 (FIG. 11) to form an additional (third) isolated channel 23 enclosing the isolated channels 19 and 20. Weld seams, connecting partitions 17 and 18, and centers of channels 19 and 20 are located on the midline of cross-section. The larger channel formed by lateral longitudinal lamellae 21 and 22 may also be elliptical in cross-section (FIG. 12).

In the first embodiment, holes 4 in the connecting partition 3 between isolated channels 1 and 2 have a specified geometry and spacing (FIG. 3). Holes 4 serve as elements of a lock joint when combined with cams 24 on the elastic service tape 25, which can have shape of elastic knobs or mushrooms, for example. The material of cams may be elastic in the case of mushrooms or rigid in the case of collets. Spatial shape of mushroom-like cams may be conical, spherical, etc., while the head of cam may partially protrude to the opposite side of connecting partition 3 (in such cases opposite service tape 26 must have mating recesses 27 able to accommodate protruding parts of cams 24 of the first service tape 25) or be flush with the partition. The number of holes 4 may be twice the number of cams 24, which allows to arrange a similar elastic service tape 26 on opposite side of the connecting partition 3 with one-hole offset in relation to the partition 3. Service tapes 25 and 26 themselves may contain service channels (electrical 30, fiber-optic 28, capillary 29, etc.). Instead of flexible service tapes 25 and 26, standard coiled tubes 31 and/or standard armored electrical cables 32 fastened with clamps 34 may be placed in the space between isolated channels 1 and 2 and the connecting partition 3 (FIG. 13), which can allow single tubing separate production using various lift methods. In the third embodiment, elastic tape 33 with service channels (electrical, capillary, etc.) is stationary and located in an additional isolated channel 12 (FIG. 7). The additional isolated channel 12 can be filled, for example, with oil, which reduces weight of the elastic service tape 33 contained therein, while oil column hydrostatic pressure compensates most part of wellbore liquid column hydrostatic pressure in isolated channels as well as serves as auxiliary path to supply oil to submersible equipment (pumps, motors, surge chambers, etc.). In another embodiment, the flexible service tape 35 may be free placed in one of isolated channels (FIG. 11). In above procedures, one metal strip may be made from steel with high tensile strength properties, whereas the second one from steel with high compressive strength properties. In such case, the string may preferably be spooled onto reel with shaped portion having high compressive strength properties faced to the reel. Such selection may be made for additional load-carrying metal tapes welded or riveted to the connecting partition 3 as well, the steel grade being selected depending on load-carrying tape position during spooling onto reel (in compression or tension zone). One of isolated channels can be used to accommodate additional enclosed hydraulic channels of the “pipe in pipe” type for submersible hydraulic pump, long-dimensional rod in an oil bath for submersible plunger or screw pump, or electric power cable with a capillary tube for submersible centrifugal or screw pump. In all three of above cases, the oil can be used to lubricate friction parts of submersible equipment.

All above embodiments of element of umbilical flexible tubing and methods for manufacturing thereof do not exclude all necessary processing procedures required to produce long flexible pipes (coiled tubing) such as edge machining, heating, sizing, etc. In addition, all proposed embodiments of element of umbilical flexible tubing can be applied in both technological operations inside boreholes and fluid production facilities and setups including complex techniques such as single tubing separate production.

All embodiments of element of umbilical flexible tubing are applicable as either conventional coil tubing or flexible lifting tubing with standard coiled tubing units but modified annular seal of stripper, injector tracks, guides, etc.

### INDUSTRIAL APPLICABILITY

The present invention makes it possible to significantly increase possibilities of coiled tubing units as well as the coiled tubing itself due to its multi-channel design and, consequently, multifunctionality.

1. An element of a lengthy umbilical flexible tubing, comprising at least two isolated channels, integrated into a single structure, wherein
the isolated channels are joined together by a connecting partition formed by welding overlapping parts of walls of the isolated channels to each other;
the isolated channels and the connecting partition are formed from two separate metal strips by shaping from a center of each metal strip by bending the metal strips longitudinally followed by welding opposite longitudinal edges of the two metal strips to each other; and
the connecting partition is made with holes and has a thickness that is about twice of a thickness of the metal strips.

2. The element according to claim 1, wherein welded seams, the connecting partition and centers of the isolated channels are located on a midline of a cross section of the tubing.

3. The element according to claim 1, wherein a service tape with connecting locking cams is mounted on the connecting partition, wherein locking cams coincide with the holes on the connecting partition, and wherein the service tape is configured in such a way that electrical cables, wires, capillary tubes, fiber optic lines are placed therein.

4. The element according to claim 1, wherein a distance between two neighboring locking cams is at least two times longer than a distance between two neighboring holes in the connecting partition.

5. An element of a lengthy umbilical flexible tubing, comprising two isolated channels integrated into a single structure, wherein
the isolated channels are joined together by a jointing partition, formed by welding overlapping parts of walls of the isolated channels to each other;
the two isolated channels and the jointing partition are formed from two separate metal strips by shaping from a center of each metal strip by bending longitudinally both edges of the metal strips to form an inner isolated channel followed by subsequent welding of contacting longitudinal edges of the metal strips to each other, and then shaping remaining two edges of the metal strips to form an outer isolated channel with subsequent welding of contacting longitudinal edges of the metal strips to each other.

6. An element of a lengthy umbilical flexible tubing, comprising two isolated channels integrated into a single structure, wherein
the isolated channels are formed from two metal strips by separately shaping each metal strip with subsequent welding longitudinal edges of each strip to each other, whereby forming said two separate isolated channels;
wherein each of said isolated channels has a crescent-shaped cross-section consisting of two circular arcs, interconnected by ends and forming a convex in the same direction, or a semicircular shape consisting of two circular arcs of different radii having ends connected by diametrical straight lines, and wherein the two isolated channels are welded to each other in places of their longitudinal mirror alignment to form an additional isolated channel between them.

7-9. (canceled)

10. The element according to claim 6, wherein each of the isolated channels has a semicircle shape in cross-section; two said isolated channels are connected to each other along diametrical planes by longitudinal welding to form a common dividing partition; and an outside line of cross-section of the tubing has a circle shape in cross-section.

11. The element according to claim 6, wherein after shaping each strip, subsequent welding of longitudinal edges of both strips to the shaped strips occur to form two separate isolated channels and two jointing partitions, followed by further shaping each strip and welding longitudinal edges of each strip to the jointing partition of opposite inner isolated channel to form two additional outer isolated channels.

12. The element according to claim 1, wherein one metal strip is made of steel with high tensile strength properties, whereas the second metal strip is made of steel with high compressive strength properties; and winding onto a reel is performed with the shaped metal strip having high compressive strength properties faced to the reel.

13. The element according to claim 6, wherein one metal strip is made of steel with high tensile strength properties, whereas the second metal strip is made of steel with high compressive strength properties; and winding onto a reel is performed with the shaped metal strip having high compressive strength properties faced to the reel.
